(19) United States
(12) Patent Application Publication
(10) Pub. No.: US 2009/0167516 A1
(43) Pub. Date: Jul. 2, 2009

(54) LOOK-AWAY DETECTING DEVICE, METHOD AND PROGRAM

(75) Inventors: Toru Kogawara, Kizukawa-shi (JP); Takuya Okamoto, Kizukawa-shi (JP); Miki Matsuoka, Osaka (JP)

Correspondence Address: OSHA LIANG L.L.P., TWO HOUSTON CENTER, 909 FANNIN, SUITE 3500, HOUSTON, TX, 77010, US

(73) Assignee: OMRON CORPORATION, Kyoto (JP)

(21) Appl. No.: 12/345,526

(22) Filed: Dec. 29, 2008

(30) Foreign Application Priority Data
Dec. 27, 2007 (JP) 2007-336505

(51) Int. Cl. B60Q 1/00; G06K 9/00

(52) U.S. Cl. 340/439; 382/100

(57) ABSTRACT

A look-away detecting system for a vehicle has an image pickup device having a camera configured to capture a face image of a driver, and a look-away detecting apparatus. The look-away detecting apparatus has a sight-line detecting unit configured to detect a direction of the driver's sight-line, a look-away detecting unit configured to detect the driver's look-away in vertical and horizontal directions based on the direction of the driver's sight-line, and to judge a degree of risk due to the driver's look-away, and a vehicle control unit that is configured to indicate the degree of risk to the driver.

### BACKGROUND OF THE INVENTION

1. Field of the Invention

The present invention relates to an inattentive driving detecting device, method and program, and more particularly, relates to a look-away detecting device, method and program to draw a driver's attention.

2. Description of Related Art

In recent years inattentive driving detecting devices have been developed to detect vehicle driver's inattentive driving and draw a driver's attention when performing inattentive driving. Among these devices, there is a device that changes a level of warning to a driver performing inattentive driving depending on whether or not a driving vehicle is approaching to an obstacle ahead. (see Japanese patent No. 3855790). Specifically, the Japanese patent proposes that a first high-emergency warning is issued upon detection of an inattentive driving of a driver looking away downward or in horizontal direction when an obstacle is detected ahead of a driving vehicle, while a second warning lower in emergency than the first warning is issued upon detection of an inattentive driving of a driver repeatedly looking away downward when no obstacle is detected ahead of the driving vehicle.

However, according to the invention described in the Japanese patent, the emergency level of warning is changed depending on detection or non-detection of an obstacle ahead of a driving vehicle, while the emergency level is not fully considered based on the condition of inattentive driving. In addition, no consideration is given for an inattentive driving of a driver looking away upward. Therefore, according to the invention described in the Japanese patent, as the condition of the driver's inattentive driving is not fully considered for the degree of risk, it is presumed that an appropriate warning corresponding to the condition of driver's inattentive driving will not be issued.

### SUMMARY

One or more embodiments of the present invention allows a vehicle driver to clearly recognize the degree of risk of look-away driving.

In accordance with an aspect of the present invention, a look-away driving detecting device is provided with a sight-line direction detection means for detecting a direction of a driver's sight line and a look-away detection means for detecting a driver's look-away in vertical and horizontal directions based on the direction of driver's sight-line and judging a degree of risk based on whether the driver is looking away in vertical direction or in horizontal direction.

According to a look-away driving detection device of an aspect of the present invention, a direction of driver's sight-line is detected, then a look-away in vertical and horizontal directions is detected based on the direction of driver's sight-line and a degree of risk is judged depending on whether the driver is looking away in vertical direction or in horizontal direction. Accordingly, the degree of risk can be precisely recognized by a driver performing look-away driving.

The sight-line direction detecting means and the look-away detecting means are configured by CPU (Central Processing Unit).

The look-away detecting means can be configured so as to judge that the look-away in vertical direction is more risky than in horizontal direction. The configuration enables a driver to recognize the degree of risk more precisely when performing look-away driving.

The look-away detecting means can be configured so as to judge the degree of risk based on the angle of a driver's sight-line. The configuration enables a driver to recognize the degree of risk more precisely when performing look-away driving.

A warning means for drawing driver's attention with intension corresponding to the degree of risk may be further provided. The warning means can appropriately draw driver's attention without causing unnecessary feeling of discomfort to the driver.

In accordance with an aspect of the present invention, a look-away driving detecting method or program includes a sight-line direction detecting step for detecting the direction of a driver's sight line and a look-away detecting step for detecting a driver's look-away in vertical and horizontal directions based on the direction of the driver's sight-line and judging a degree of risk depending on whether the driver is looking away in vertical direction or in horizontal direction.

According to a look-away driving detecting method or program of an aspect of the present invention, the direction of driver's sight line is detected, then a driver's look-away in vertical and horizontal directions is detected based on the direction of the driver's sight line and a degree of risk is judged depending on whether the driver is looking away in vertical direction or in horizontal direction. Thus, the degree of risk can be precisely recognized by the driver when performing look-away driving.

The sight-line direction detecting step is constituted, for example, by a sight-line direction detecting process of CPU that detects the direction of a driver's sight line and the look-away detecting step is constituted, for example, by a look-away detecting process of CPU that detects a driver's look-away in vertical and horizontal directions based on the direction of the driver's sight line and judges a degree of risk depending on whether the driver is looking away in vertical direction or in horizontal direction. Therefore, according to an aspect of the present invention, the degree of risk due to driver's look-away driving can be recognized more precisely by the driver.

### BRIEF DESCRIPTION OF THE DRAWINGS

FIG. 1 is a block diagram showing an embodiment of a look-away system according to one or more embodiments of the present invention.

FIG. 2 is a flowchart illustrating a look-away detecting program.

FIG. 3 is a block diagram showing an example of the configuration of CPU.

### DETAILED DESCRIPTION

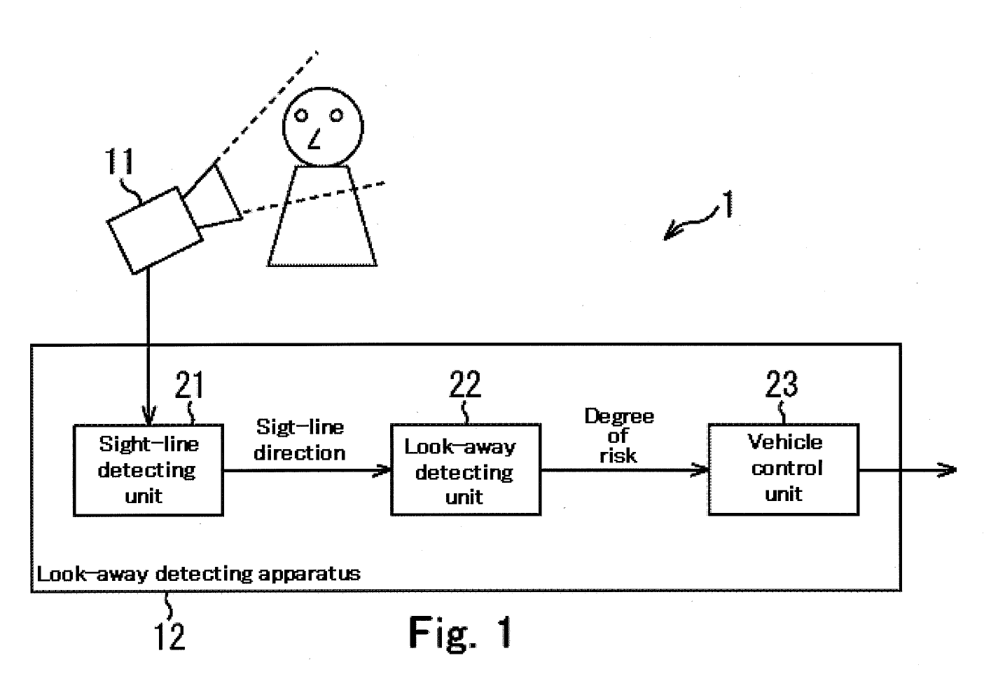

In the following detailed description, reference is made to the accompanying FIGS. 1 through 3, which illustrate the described embodiments. The embodiments are described in sufficient detail to enable those skilled in the art to make and use them.

FIG. 1 is a view showing a block diagram of an embodiment of look-away detecting system 1 according to one or more embodiments of the present invention. Look-away detecting system 1 detects a look-away of a driver driving a vehicle provided with look-away system 1 (hereinafter referred to as self-vehicle), then performs an operation to have the driver avoid the risk due to the look-away driving. The look-away detecting system 1 is configured to include image-pickup apparatus 11 and look-away detecting apparatus 12.

Image-pickup apparatus 11 is configured with a camera employing, for example, CCD (Charge Coupled Devices), CMOS (Complementary Metal Oxide Semiconductor) or logarithmic-conversion type image-pickup devices, etc. Image-pickup apparatus 11 is arranged to pick up a full face image of a driver driving a self-vehicle at specific time intervals and sends the pick-up image (hereinafter referred to as face image) to sight-line detecting unit 21 of look-away detecting apparatus 12.

Look-away detecting apparatus 12 is configured to include sight-line detecting unit 21, look-away detecting unit 22 and vehicle control unit 23.

Sight-line detecting unit 21 detects the direction of driver's sight-line based on the face image using a specific method. For example, sight-line detecting unit 21 detects angles of the driver's sight-line in vertical and horizontal directions. Sight-line detecting unit 21 supplies look-away detecting unit 22 with the detected information including the direction of the driver's sight-line (e.g., 20 degree upward and 30 degree rightward, etc.). There is no limitation for the method for detecting the direction of the sight-line using sight-line detecting unit 21. The method capable of detecting the direction of sight-line more promptly, accurately and simply is more preferable.

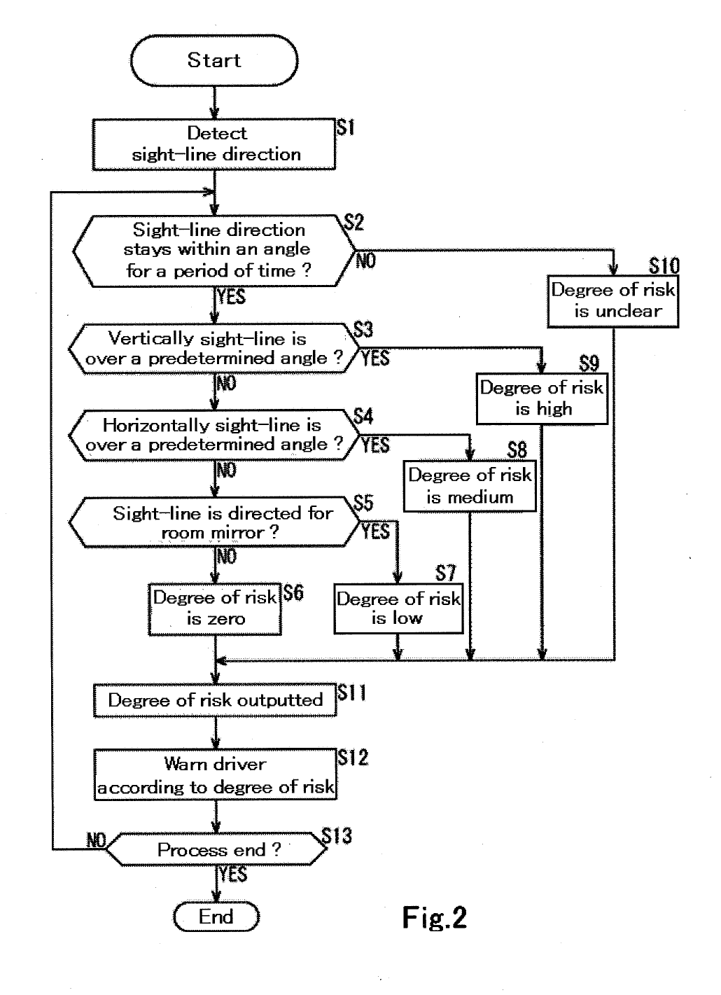

Look-away detecting unit 22, as described later referring to FIG. 2, detects a driver looking away in vertical and horizontal directions based on the direction of driver's sight-line detected by sight-line detecting unit 21. Look-away detecting unit 22, as described later referring to FIG. 2, judges a degree of risk due to driver's look-away driving based on the look-away direction detected by look-away detecting unit 22. Look-away detecting unit 22 supplies vehicle control unit 23 with the information including the degree of risk due to driver's look-away driving.

In the meantime, man's eyesight is narrower in vertical direction than in horizontal direction. Thus, when a driver looks away in vertical direction to a vehicle traveling direction, the vehicle traveling direction hardly comes into sight, thus the degree of risk increases higher than the driver looks away in horizontal direction. Accordingly, look-away detecting section 22, as described later referring to FIG. 2, judges that the degree of risk due to look-away in vertical direction is higher than look-away in horizontal direction.

Vehicle control unit 23 is configured with, for example, ECU (Electronic Control Unit), etc. and controls the operations of the self-vehicle and various types of in-vehicle units provided in the self-vehicle, thus draws attention of the driver when performing look-away driving with an intension corresponding to the degree of risk.

Next, look-away detecting process executed by look-away detecting system 1 is described referring to a flowchart shown in FIG. 2. This process gets started for example when an ignition switch is turned on and an engine starts.

Sight-line detecting unit 21 starts to detect the direction of driver's sight-line in Step S1. Specifically, image pick-up apparatus 11 starts to pick up the face image of a driver and send the face image to sight-line detecting unit 21. Sight-line detecting unit 21 starts to detect the direction of the driver's sight-line based on the face image and send the detected information including the direction of the sight-line to look-away detecting unit 22.

In Step S2, look-away detecting unit 22 judges whether or not the driver's sight-line direction stays within a predetermined angle (e.g. within 5 degree) for a predetermined period of time (e.g., for 1 second). If it is judged that the driver's sight-line direction stays within a predetermined angle for a predetermined period of time, in other words if the direction of the driver's sight-line is stable, process goes to Step S3.

In Step S3, look-away detecting unit 22 judges whether or not the direction of the sight-line stays vertically within a predetermined angle. Look-away detecting unit 22 judges that the sight-line stays vertically within a predetermined angle if, for example, the average angle of the vertical direction of the sight-line during a period from a predetermined time before (e.g., 1 second before) to the present time is within a predetermined angle (±20 degree), then process goes to Step S4.

In Step S4, look-away detecting unit 22 judges whether or not the direction of the sight-line stays horizontally within a predetermined angle. Look-away detecting unit 22 judges that the sight-line stays horizontally within a predetermined angle if the average angle of the horizontal direction of the sight-line during a period from a predetermined time before (e.g. 1 second before) to the present time is within a predetermined angle (±40 degree), then process goes to Step S5.

In Step S5, look-away detecting unit 22 judges whether or not the sight-line is directed toward a room mirror. Look-away detecting unit 22 judges that the sight-line is not directed toward the room mirror if the average angle of the sight-line direction during a period from a predetermined time before (e.g. 1 second before) to the present time is not within a predetermined angle, then process goes to Step S6.

In Step S6, look-away detecting unit 22 judges that the degree of risk is zero. In other words, if the directions of the driver's sight-line are within predetermined angles vertically as well as horizontally and the driver does not see in the direction of the mirror, no risk due to look-away driving is judged, then process goes to Step S11.

On the other hand, in Step S5, look-away detecting unit 22 judges that the sight-line is directed toward the room mirror if the average angle of the sight-line direction during a period from a predetermined time before (e.g. 1 second before) to the present time is within a predetermined angle, then process goes to Step S7.

In Step S7, look-away detecting unit 22 judges that the degree of risk is low. It is easy to get the sight-line back to the front direction when the driver sees in the direction of the room mirror, thus the degree of risk due to look-away driving is judged as low. After that, process goes to Step S11.

On the other hand, in Step S4, look-away detecting unit 22 judges that the sight-line horizontally exceeds a predetermined angle if the average angle of the horizontal direction of the sight-line during a period from a predetermined time before to the present time exceeds a predetermined angle, then process goes to Step S8.

In Step 8, look-away detecting unit 22 judges that the degree of risk is medium. In other words, if a driver is looking away not vertically but horizontally when driving, it is probable that the driver does not see the front of the vehicle while seeing around the vehicle, thus the degree of risk due to look-away driving is judged as medium. After that process goes to Step S11.

On the other hand, in Step S3, look-away detecting unit 22 judges that the sight-line vertically exceeds a predetermined angle if the average angle of the vertical direction of the sight-line during a period from a predetermined time before to the present time exceeds a predetermined angle, then process goes to Step S9.

In Step S9, look-away detecting unit 22 judges that the degree of risk is high. In other words, if a driver is looking away vertically regardless of horizontal direction of driver's sight-line when driving, it is probable that the driver sees very little around the vehicle, thus the degree of risk due to driver's look-away driving is judged as high. After that process goes to Step S11.

On the other hand, in Step S2, if it is judged that the driver's sight-line does not stay within a predetermined angle for a predetermined period of time, in other words if the direction of the driver's sight-line is unstable, process goes to Step S10.

In Step S10, look-away detecting unit 22 judges that the degree of risk is unclear. In other words, because the direction of driver's sight-line is unstable and whether or not a driver is looking away cannot be judged, the degree of risk due to driver's look-away driving is judged as unclear. After that process goes to Step S11.

In Step S11, look-away detecting unit 22 issues the degree of risk. More specifically, look-away detecting unit 22 sends the information including the judged degree of risk of look-away driving to vehicle control unit 23.

In Step S12, vehicle control unit 23 draws a driver's attention with intention corresponding to the degree of risk. For example, vehicle control unit 23, when the degree of risk is low, gives a warning or an alarm to draw driver's attention using a sound output unit (e.g. speaker, etc.) provided in the self-vehicle (not shown). Vehicle control unit 23, when the degree of risk is intermediate level, for example, gives a warning or an alarm with a larger volume compared to the case when the degree of risk is low and draws driver's attention with more distinct way compared to the case when the degree of risk is low. Further, vehicle control unit 23, when the degree of risk is high, for example, gives a warning with the same volume of the case when the degree of risk is intermediate level and makes driver's seat belt fasten tighter using a seat belt fasten-control device (not shown) and draws driver's attention with more distinct way compared to the case when the degree of risk is intermediate level. When the degree of risk is unclear, no particular process is executed.

In Step S13, look-away detecting system 1 judges whether to end the process. For example, if the ignition switch of the self-vehicle is held on state, look-out detecting system 1 judges not to end the process, the process goes back to Step S2, and the processes from Step S2 through Step 13 are repeatedly executed until the process is judged to end in Step S13.

On the other hand, in Step S13, for example, when the ignition switch of the self-vehicle is set off and the engine stops, look-away detecting system 1 judges to end the process and look-away detecting process is terminated.

The degree of risk of driver's look-away driving is precisely recognized by the driver in this way. It is possible to appropriately draw driver's attention corresponding to the degree of risk. Accordingly, safety of driving is improved and inappropriate warning causing unnecessary feeling of discomfort to the driver is controlled.

The above example shows that the degree of risk is divided into three levels, high, intermediate, and low. However, more precisely or more roughly the degree of risk may be divided. For example, the degree of risk may be divided so precisely that it rises as the sight-line angle increases vertically or horizontally. Alternatively, for example, the degree of risk may be divided so precisely that it rises as the speed of the vehicle increases.

When the driver's sight-line is directed to an in-vehicle instrument other than the room mirror, such as a side mirror the driver must watch during driving, the degree of risk may be judged as the same with the case when the driver's sight-line is directed to the room mirror.

Further, a table correlating the look-away direction with the degree of risk may be prepared so that the degree of risk is judged using the table.

Alternatively, the tone of warning sound or the message other than the volume of warning sound may be changed corresponding to the degree of risk. In addition, when look-away is detected, a warning lamp is lit or blinked and the color, type or the blink rate of the warning lamp may be changed corresponding to the degree of risk. Further, when look-away is detected, a vibrating body built in a driver's seat or a steering wheel is activated and the power of the vibration may be changed corresponding to the degree of risk.

Further, when look-away is detected, a brake of the self-vehicle is operated and the self-vehicle may be slowed down.

Further more, the direction of driver's face is detected and when the direction of the driver's sight-line cannot be detected, the degree of risk may be judged corresponding to the direction of driver's face.

These series of processes as described above may be executed by a hardware as well as a software. When these series of processes are executed by a software, the program configuring the software is installed through a program recording media into a computer built in a single-purpose hardware or, for example, into a multi-purpose personal computer capable of executing a various kind of functions by installing various types of programs.

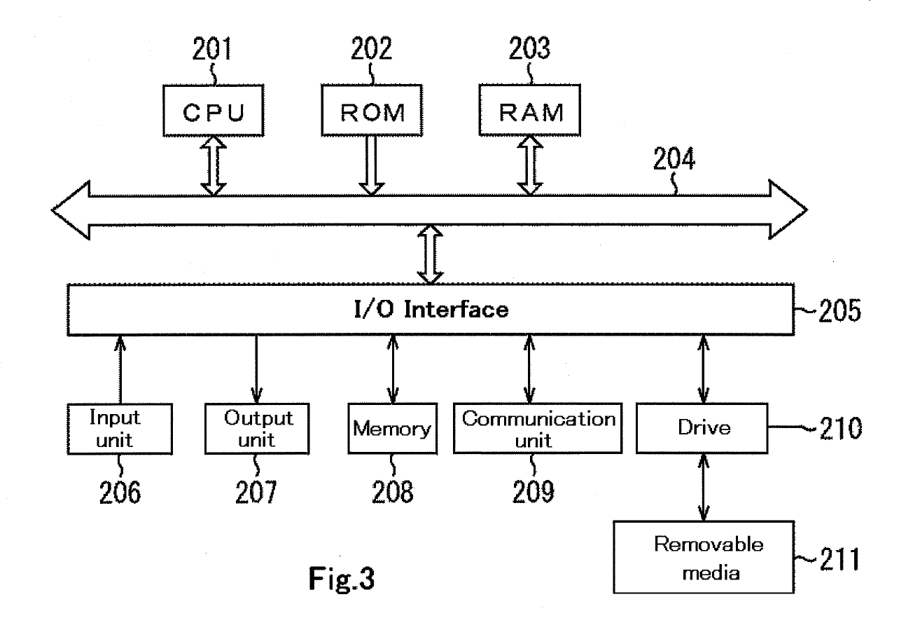

FIG. 3 is a block diagram showing the configuration of a hardware of a computer executing the above described series of processes by program.

In the computer, CPU (Central Processing Unit) 201, ROM (Read Only Memory) 202 and RAM (Random Access Memory) 203 are mutually connected by bus 204.

Also input-output interface 205 is connected to bus 204. Input-output interface 205 is connected by an input unit 206 including a keyboard, a mouse, microphone, etc., an output unit 207 including a display, a speaker, etc., a memory 208 including a hard disc, non-volatile memory, etc., a communication unit 209 including a network interface etc., and a drive 210 for driving removable media 211 such as a magnetic disc, a photo disc, photo-magnetic disc or semiconductor memory.

In the computer with configuration as described above, CPU 201 loads RAM 203 with the program stored in memory 208 through input-output interface 205 and bus 204 and executes the program so as to go through the above described series of processes.

The program executed by a computer (CPU 201) is stored in and provided through removable media 211, i.e. a package media including, for example, a magnetic disc (flexible disc included), a photo disc (CD-ROM(Compact Disc-Read Only Memory), DVD(Digital Versatile Disc) etc.), a photo-magnetic disc or a semiconductor memory. Alternatively, the program is provided through wired or wireless transmission media such as a local area network, an internet, and a digital satellite broadcasting.

The program can be installed in memory 208 through input-output interface 205 by attaching removable media 211 to drive 210. Alternatively, the program can be received by communication unit 209 and installed in memory 208 through wired or wireless transmission media. Furthermore, the program can be preinstalled in ROM 202 or memory 208 as well.

The program may be executed by the computer either in time series as illustrated in FIG. 2 or in parallel, or at a necessary timing in response to a calling.

The term “system” is used for implying an apparatus as a whole, comprising a plurality of devices and means.

In the above description and drawings are only to be illustrative of exemplary embodiments which achieve the aspects and advantages described above. Modifications of, and substitutions to, specific operating conditions and structures can be made without departing from the spirit and scope of the invention.

Accordingly, the claimed invention is not to be considered as being limited by the foregoing description and drawings, but is only limited by the scope of the appended claims.

1. A look-away detecting device, comprising:
a sight-line direction detecting means for detecting the direction of a driver's sight-line; and
a look-away detecting means for detecting a driver's look-away in vertical and horizontal directions based on the direction of the driver's sight-line and judging a degree of risk based on whether the driver looks away in vertical direction or in horizontal direction.

2. The look-away detecting device according to claim 1: wherein the look-away detecting means judges so that the degree of risk due to the look-away in vertical direction is higher than in horizontal direction.

3. The look-away detecting device according to claim 1: wherein the look-away detecting means judges the degree of risk based on the angle of the driver's sight-line.

4. The look-away detecting device according to claim 3: wherein the look-away detecting means judges the degree of risk as low if the angle of the driver's sight-line is within a predetermined angle corresponding to the direction of a room mirror or a side mirror.

5. The look-away detecting device according to claim 1, further comprising: a warning means for drawing the driver's attention with intension corresponding to the degree of risk.

6. A look-away detecting method, comprising:
detecting the direction of a driver's sight-line; and
detecting a driver's look-away in vertical and horizontal directions based on the direction of the driver's sight-line; and
judging a degree of risk based on whether the driver looks away in vertical direction or in horizontal direction.

7. A computer readable medium storing a look-away detecting program, the program comprising functionality to cause the computer to perform:
detecting the direction of a driver's sight-line;
detecting a driver's look-away in vertical and horizontal directions based on the direction of the driver's sight-line; and
judging a degree of risk based on whether the driver looks away in vertical direction or in horizontal direction.

8. A look-away detecting system for a vehicle comprising:
an image pickup device comprising a camera configured to capture a face image of a driver; and
a look-away detecting apparatus comprising:
a sight-line detecting unit configured to detect a direction of the driver's sight-line,
a look-away detecting unit configured to detect the driver's look-away in vertical and horizontal directions based on the direction of the driver's sight-line, and to judge a degree of risk due to the driver's look-away, and
a vehicle control unit that is configured to indicate the degree of risk to the driver.
